(19) United States
(12) Patent Application Publication
(10) Pub. No.: US 2025/0087083 A1
(43) Pub. Date: Mar. 13, 2025

(54) TRAFFIC RISK ESTIMATION DEVICE

(71) Applicant: Toyota Jidosha Kabusha Kaisha, Toyota-shi (JP)

(72) Inventor: Satoshi UNO, Mishima-shi (JP)

(73) Assignee: TOYOTA JIDOSHA KABUSHIKI KAISHA, Toyota-shi (JP)

(21) Appl. No.: 18/769,535

(22) Filed: Jul. 11, 2024

(30) Foreign Application Priority Data
Sep. 11, 2023 (JP) 2023-146858

(51) Int. Cl. G08G 1/01

(52) U.S. Cl. CPC G08G 1/0133; G08G 1/0112

(57) ABSTRACT

A traffic risk estimation device includes: a data generation unit that generates aggregated data regarding a predetermined dangerous phenomenon from vehicle data acquired in an entire target area including a plurality of unit areas; and a risk determination unit that determines a traffic risk for each of the plurality of unit areas based on the aggregated data.

### FIELD

The present disclosure relates to a traffic risk estimation device.

### BACKGROUND

JP2021-89698A discloses detecting an intersection that exists in front of a host vehicle and has a blind spot, and activating driving assistance functions such as displaying caution images at the detected intersection.

### SUMMARY

However, even if the intersection has a blind spot, it does not necessarily mean that jumping out by pedestrians or the like is likely to occur at that intersection. Therefore, when the driving assistance function is always activated at such an intersection, the driver of the vehicle may feel that the function is troublesome. Further, even when a recognition sensor such as an in-vehicle camera is used, there is a possibility that a dangerous intersection in front of the vehicle cannot be detected. Therefore, there is a possibility that the driving assistance function is not properly activated in a place where the traffic risk is high. Therefore, it is desired to accurately estimate the traffic risk at a place where the vehicle travels so that the driving assistance function is activated at an appropriate timing.

The present disclosure has been made focusing on such problems, and an object thereof is to improve the accuracy of the estimation of the traffic risk for each area.

The gist of the present disclosure is as follows:
(1) A traffic risk estimation device including a data generation unit that generates aggregated data regarding a predetermined dangerous phenomenon from vehicle data acquired in an entire target area including a plurality of unit areas and a risk determination unit that determines a traffic risk for each of the plurality of unit areas based on the aggregated data.
(2) The traffic risk estimation device according to the above (1), further including a risk reevaluation unit that subdivides an area determined to have a high traffic risk into individual area, and reevaluates a traffic risk of the individual area based on the number of occurrences of the dangerous phenomenon in the individual area.
(3) The traffic risk estimation device according to the above (2), wherein the individual area is the unit area, and when the number of occurrences of the dangerous phenomenon in the unit area is zero, a traffic risk of the unit area is lowered.
(4) The traffic risk estimation device according to the above (2) or (3), wherein the individual area is a small area narrower than the unit area, and when the number of occurrences of the dangerous phenomenon in the small area is less than a predetermined value, a traffic risk of the small area is lowered.
(5) The traffic risk estimation device according to the above (4), wherein the small area includes only one intersection.

According to this aspect of the present disclosure, the accuracy of the estimation of the traffic risk for each area can be improved.

### BRIEF DESCRIPTION OF DRAWINGS

FIG. 1 is a schematic view of a traffic risk estimation system according to an embodiment of the present disclosure.

FIG. 2 is a functional block view of a processor of the server.

FIG. 3A is a flowchart showing a control routine executed to estimate the traffic risk for each area in the present embodiment.

FIG. 3B is a flowchart showing a control routine executed to estimate the traffic risk for each area in the present embodiment.

FIG. 4 is a view showing an example of a high-risk area in a target area.

### DESCRIPTION OF EMBODIMENTS

Below, referring to the drawings, an embodiment of the present disclosure will be explained in detail. Note that, in the following explanation, similar component elements will be assigned the same reference notations.

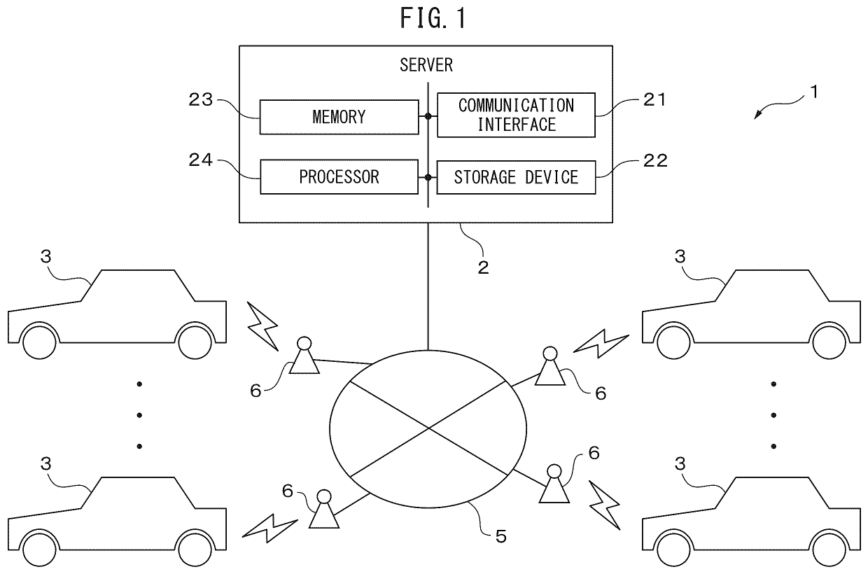

FIG. 1 is a schematic view of a traffic risk estimation system 1 according to an embodiment of the present disclosure. As shown in FIG. 1, the traffic risk estimation system 1 includes a server 2 and a plurality of vehicles 3. The server 2 can communicate with each of the plurality of vehicles 3 via a communication network 5, such as an Internet network, and a radio base station 6 connected to the communication network 5. The communication between the vehicles 3 and the radio base station 6 is performed by known radio communication techniques (e.g., 3G, LTE (Long Term Evolution), 4G, 5G, etc.).

As shown in FIG. 1, the server 2 is provided outside the plurality of vehicles 3, and includes a communication interface 21, a storage device 22, a memory 23, and a processor 24. The communication interface 21, the storage device 22, and the memory 23 are connected to the processor 24 via a signal line. Note that the server 2 may further include an input device such as a keyboard and a mouse, an output device such as a display, and the like. The server 2 may include a plurality of computers.

The communication interface 21 is capable of communicating with the plurality of vehicles 3, and enables the server 2 to communicate with the plurality of vehicles 3. Specifically, the communication interface 21 has an interface circuit for connecting the server 2 to the communication network 5. The server 2 communicates with the outside of the server 2 (e.g., a plurality of vehicles 3) via the communication interface 21 and the communication network 5. The communication interface 21 is an example of a communication unit of the server 2.

The storage device 22 includes, for example, a hard disk drive (HDD), a solid state drive (SSD), an optical recording medium, and an accessing device thereof. The storage device 22 stores various kinds of data, and stores, for example, map information, a computer program for the processor 24 to execute various kinds of processing, and the like. The storage device 22 is an example of a storage unit of the server 2.

The memory 23 includes a non-volatile semiconductor memory (e.g., a RAM). The memory 23 temporarily stores, for example, various kinds of data used when various kinds of processing are executed by the processor 24. The memory 23 is another example of a storage unit of the server 2.

The processor 24 includes one or more CPUs and peripheral circuitry thereof, and executes various processes. The processor 24 may further include other arithmetic circuits such as a logical arithmetic unit, a numerical arithmetic unit, or a graphic processing unit.

The vehicle 3 includes a peripheral information detection device, a GNSS (Global Navigation Satellite System) receiver, a vehicle behavior detection device, an actuator, a human machine interface (HMI), a communication device, an electronic control unit (ECU), and the like. The peripheral information detection device, the GNSS receiver, the vehicle behavior detection device, the actuator, the HMI, and the communication device are electrically connected to ECU via an in-vehicle network or the like compliant with standards such as CAN (Controller Area Network).

The peripheral information detection device acquires data (images, point cloud data, and the like) around the vehicle 3, and detects peripheral information of the vehicle 3 (e.g., a peripheral vehicle, a pedestrian, a two-wheeled vehicle, a lane, a falling object, an animal, a construction site, and the like). For example, the peripheral information detection device includes a millimeter-wave radar, a camera (monocular camera or stereo camera), a LIDAR (Laser Imaging Detection And Ranging), or an ultrasonic sensor (sonar), or any combination thereof. Outputs of the peripheral information detection device, that is, the peripheral information of the vehicle 3 detected by the peripheral information detection device is transmitted to ECU.

GNSS receiver detects the present position of the vehicle 3 (e.g., the latitude and longitude of the vehicle) based on positioning information obtained from a plurality of (e.g., three or more) positioning satellites. The output of GNSS receiver, that is, the present position of the vehicle 3 detected by GNSS receiver, is transmitted to ECU.

The vehicle behavior detection device detects behavior information of the vehicle 3. The vehicle behavior detection device includes, for example, a vehicle speed sensor that detects a speed of the vehicle 3, an acceleration sensor that detects an acceleration of the vehicle 3, a brake pedal stroke sensor that detects a depression force of a brake pedal provided in the vehicle 3, and the like. Output from the vehicle behavior detection device, that is, behavior information of the vehicle 3 detected by the vehicle behavior detection device is transmitted to ECU.

The actuator operates the vehicle 3. For example, the actuator includes a driving device (e.g., at least one of an internal combustion engine or an electric motor) for acceleration of the vehicle 3, a brake actuator for braking the vehicle 3, a steering actuator for steering the vehicle 3, and the like. ECU controls the actuator to control the behavior of the vehicle 3.

The HMI is an interface for inputting and outputting information between the vehicle 3 and an occupant (e.g., a driver) of the vehicle 3. The HMI includes an output unit (e.g., a display, a speaker, a vibrating unit, and the like) that provides information to the occupant of the vehicle 3, and an input unit (e.g., a touch panel, an operation button, an operation switch, a microphone, and the like) to which information is input by the occupant of the vehicle 3. The output of ECU is notified to the occupant of the vehicle 3 via the HMI, and the input from the occupant of the vehicle 3 is transmitted to ECU via the HMI.

The communication device is capable of communicating with the outside of the vehicle 3, and enables communication between the vehicle 3 and the outside of the vehicle 3 (e.g., the server 2). For example, the communication device is a wide area radio communication device (e.g., a data communication module (DCM)) that enables wide area communication between the vehicle 3 and the outside of the vehicle 3.

ECU includes a communication interface, memories, and processors, and executes various controls of the vehicles 3. That is, ECU functions as a control device for the vehicles 3.

In the present embodiment, the vehicle 3 includes an advanced driving assistant system (ADAS) and performs a predetermined driving assistance function. As a specific example, the vehicle 3 performs pre-crash safety (PCS) as a driving assistance function. In PCS, the warning and the braking control are activated in a stepwise manner as Time To Collision (TTC) for an obstacle (a surrounding vehicle, a pedestrian, a bicycle, or the like) in front of the vehicle 3 is shortened.

In addition, the vehicle 3 performs blind spot intersection assist as a driving assistance function. In the blind spot intersection assist, the deceleration control of the vehicle 3 is activated as necessary at an intersection having a blind spot (hereinafter referred to as a “blind spot intersection”), and when a moving object such as a pedestrian is detected, the steering control for avoiding the moving object is activated. The blind spot intersection is detected based on the output of the peripheral information detection device of the vehicle 3.

Each of the vehicles 3 transmits vehicle data related to the behavior of the vehicle 3 to the server 2, and the server 2 generates traffic information based on the vehicle data. In the present embodiment, the server 2 estimates the traffic risk for each area, and generates a hazard map indicating the traffic risk for each area as the traffic information. The server 2 is an example of a traffic risk estimation device.

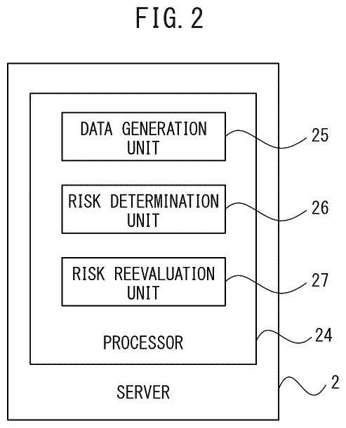

FIG. 2 is a functional block view of a processor 24 of the server 2. In the present embodiment, the processor 24 includes a data generation unit 25, a risk determination unit 26, and a risk reevaluation unit 27. The data generation unit 25, the risk determination unit 26, and the risk reevaluation unit 27 are functional modules realized by the processor 24 of the server 2 executing a computer program stored in the storage device 22 of the server 2. Note that these functional modules may be realized by a dedicated arithmetic circuit provided in the processor 24.

In the present embodiment, the server 2 estimates the traffic risk in a predetermined target area and generates the hazard map of the target area. The target area includes a plurality of unit areas, and the risk determination unit 26 determines the traffic risk for each of the plurality of unit areas. At this time, if the traffic risk of a specific unit area is determined based only on the vehicle data acquired in the unit area, only the location where a large number of the vehicle data related to the dangerous phenomenon is acquired is determined as an area where the traffic risk is high, and thus a potentially dangerous area cannot be extracted. For example, even if there is a unit area surrounded by an area with a high traffic risk, it is determined that the traffic risk of the unit area is low unless a dangerous phenomenon occurs in the unit area.

Therefore, in the present embodiment, the data generation unit 25 creates aggregated data regarding a predetermined dangerous phenomenon from the vehicle data acquired in the entire target area, and the risk determination unit 26 determines the traffic risk for each of the plurality of unit areas based on the aggregated data created by the data generation unit 25. This makes it possible to reflect the vehicle data acquired in the other unit area in the determination of the traffic risk of the specific unit area. Therefore, it is possible to extract a potentially dangerous area, and thus, it is possible to improve the estimation accuracy of the traffic risk for each area.

In the present embodiment, the predetermined dangerous phenomenon is an activation of an alarm in PCS, an activation of a braking control (automatic braking) in PCS, an activation of an airbag, an activation of a sudden braking, and an activation of the blind spot intersection assist, and vehicle data transmitted from the vehicle 3 to the server 2 includes, for example, a PCS signal indicating an activation status of PCS, an ABG signal indicating an activation status of the airbag, a brake signal indicating an output of the brake pedal stroke sensor, an acceleration signal indicating an output of the acceleration sensor, a vehicle speed signal indicating an output of the vehicle speed sensor, and activation information of the blind spot intersection assist. In addition to the vehicle data, the plurality of vehicles 3 each transmit identification information of the vehicle 3 (e.g., vehicle ID), acquisition position information of the vehicle data (e.g., latitude and longitude of the location where the vehicle data is acquired), and acquisition time of the vehicle data to the servers 2 periodically (e.g., at one-minute intervals).

The data generation unit 25 creates aggregated data from the vehicle data. For example, the aggregated data is created for each unit area, and includes a feature value related to a dangerous phenomenon occurring in the unit area. In the present embodiment, the aggregated data includes five feature values: the number of times the alarm is activated in PCS, the number of times the braking control is activated in PCS, the number of times the airbag is activated, the number of times the sudden braking is activated, and the number of times the blind spot intersection assist is activated. The number of times the alarm is activated in PCS and the number of times the braking control is activated in PCS are calculated based on the PCS signal, and the number of times the airbag is activated is calculated based on the ABG signal. The number of sudden braking operations is calculated based on at least one of the brake signal, the acceleration signal, or the vehicle speed signal. The number of times the blind spot intersection assist is activated is calculated based on the activation information of the blind spot intersection assist. The aggregated data for each unit area is stored in the storage device 22 or the memory 23 of the server 2.

For example, the risk determination unit 26 determines the traffic risk for each of the plurality of unit areas by inputting the aggregated data generated by the data generation unit 25 to the discriminator. Specifically, the risk determination unit 26 determines the traffic risk for each of the plurality of unit areas by inputting the aggregated data of all the unit areas included in the target area to the discriminator. The discriminator is learned in advance to output the traffic risk for each of the plurality of unit areas from the aggregated data. In this case, for example, 0, 1, and 2 are output from the discriminator as values corresponding to the traffic risks of “low”, “medium”, and “high” Examples of such an discriminator include a neural network, a support vector machine, a machine learning model such as a random forest, an estimation model based on kernel-density estimation, and the like.

Note that, instead of generating the aggregated data for each unit area from the vehicle data acquired in the entire target area, the data generation unit 25 may generate the aggregated data for the entire target area from the vehicle data acquired in the entire target area. In this case, for example, the acquired position information of the vehicle data or the identification number of the unit area in which the vehicle data is acquired is added as the feature value of the aggregated data. Further, in this case, the risk determination unit 26 determines the traffic risk for each of the plurality of unit areas by inputting the aggregated data of the entire target area to the discriminator.

Further, the risk determination unit 26 may determine the traffic risk for each of the plurality of unit areas based on the aggregated data by using a rule-based estimation method. In this case, for example, the risk determination unit 26 determines that the danger level of the unit area in which the number of times of occurrence of the dangerous phenomenon is equal to or greater than a predetermined threshold value is “high”, and determines that the danger level of the unit area adjacent to the unit area in which the traffic risk is determined to be high is “medium”. When the rule-based estimation method is used, a method such as kernel-density estimation may be used to determine the traffic risk in the unit area in which vehicle data is not acquired.

As described above, when the traffic risk of the unit area in the target area is determined based on the occurrence status of the dangerous phenomenon in the entire target area, while the potentially dangerous area can be extracted, there is a possibility that the traffic risk of the area having a very low danger level is actually determined to be high. Further, even if it is determined that the traffic risk of a specific unit area is high, the traffic risk of the entire unit area is not necessarily high.

Therefore, in the present embodiment, the risk reevaluation unit 27 subdivides the area determined by the risk determination unit 26 to be high in the traffic risk into individual areas, and reevaluates the traffic risk of the individual areas based on the number of occurrences of the dangerous phenomenon in the individual areas. As a result, it is possible to exclude an area where the danger phenomenon is actually unlikely to occur from an area where the traffic risk is high, and thus it is possible to further improve the accuracy of the estimation of the traffic risk for each area.

For example, even if a unit area surrounded by an area where the dangerous phenomenon frequently occurs exists, if the dangerous phenomenon does not occur in the unit area, it is unlikely that the dangerous phenomenon will occur in the future in the unit area. Therefore, when an area determined to have a high traffic risk (hereinafter referred to as a “high-risk area”) includes a plurality of unit areas, the risk reevaluation unit 27 subdivides the high-risk area into unit areas, and when the number of times of occurrence of the dangerous phenomenon in the unit area is zero, lowers the traffic risk of the unit area.

Further, even if a unit area determined as the high-risk area exists, if the occurrence frequency of the dangerous phenomenon is low in a part of the area of the unit area, it is desirable to reduce the traffic risk for the part of the area. Therefore, the risk reevaluation unit 27 subdivides the high-risk area into small areas narrower than the unit area, and lowers the traffic risk of the small area when the number of times of occurrence of the dangerous phenomenon in the small area is less than a predetermined value.

In the present embodiment, the risk reevaluation unit 27 subdivides the unit area into small areas so that the number of intersections in the small area is one. That is, only one intersection is included in the small area. As a result, the traffic risk can be re-evaluated for each intersection included in the unit area, and a more detailed hazard map can be provided.

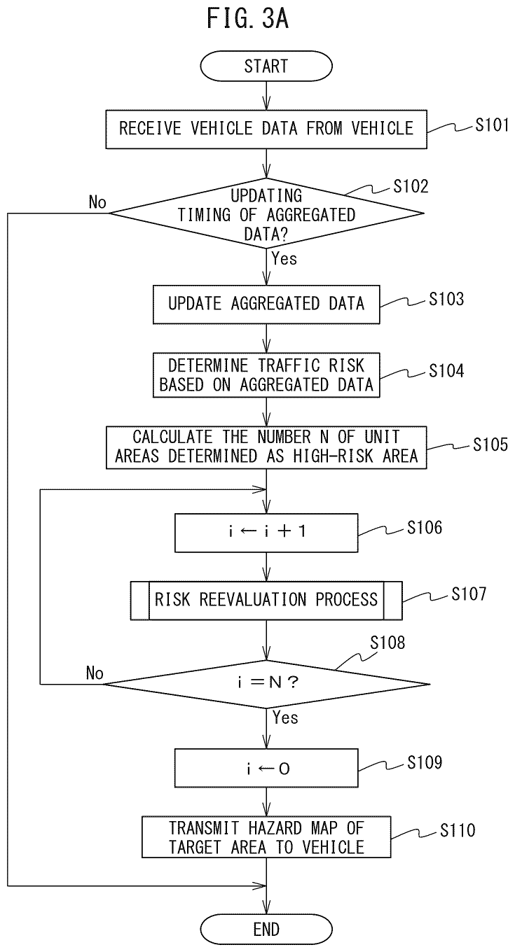

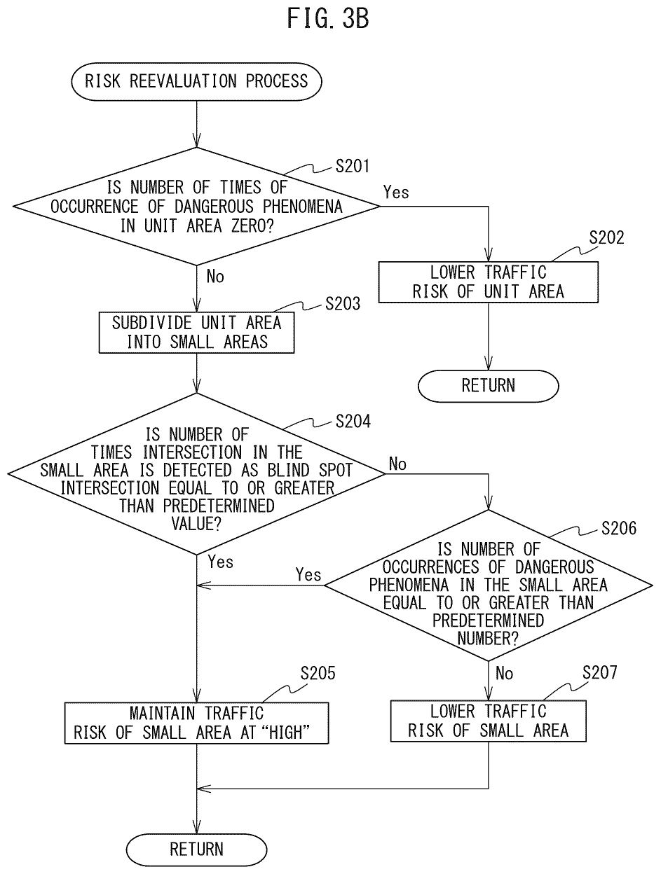

Referring to FIG. 3A and FIG. 3B, a process flow of the above-described control will be described below. FIG. 3A and FIG. 3B are flowcharts showing a control routine executed to estimate the traffic risk for each area in the present embodiment. This control routine is repeatedly executed by the processor 24 (the data generation unit 25, the risk determination unit 26, and the risk reevaluation unit 27) of the server 2 at predetermined execution interval. The predetermined execution interval is, for example, an interval (e.g., one minute) at which vehicle data is transmitted from the vehicle 3 to the server 2.

The target area in which the traffic risk is estimated by the control routine is predetermined and includes a plurality of unit areas. Each unit area is classified by, for example, a region mesh obtained by dividing a map according to latitude and longitude, and is specified by a code (mesh code) defined by the region mesh. In the present embodiment, the size of the respective unit areas is a 125 [m] mesh (⅛ area mesh) having a 125 [m] length of one side. The size of the respective unit areas may be a third-order mesh (reference area mesh) having a 1 [km] length of one side.

At step S101, the data generation unit 25 receives vehicle data from each of the plurality of vehicles 3. At this time, the acquisition position of the vehicle data is determined based on the acquisition position information of the vehicle data, and only the vehicle data acquired in the target area is stored in the storage device 22 or the memory 23 of the server 2. Note that only the vehicle data acquired within a predetermined distance (e.g., within a 20 [m]) from the center of the intersection within the target area may be stored in the storage device 22 or the memory 23 of the server 2. This makes it possible to extract vehicle data acquired in the vicinity of the intersection where the traffic risk tends to be high. In addition, the vehicle 3 may transmit only the vehicle data acquired in the target area or only the vehicle data acquired within the predetermined distance (e.g., within a 20 [m]) from the center of the intersection in the target area to the servers 2.

At step S102, the data generation unit 25 determines whether or not it is the updating timing of the aggregated data. The update interval of the aggregated data is, for example, one hour, and in this case, it is determined that it is the update timing of the aggregated data when one hour has elapsed from the previous update timing. The update interval of the aggregated data may be one day, one week, one month, or the like. If it is determined at S102 that the timing is not the timing of updating the aggregated data, the present control routine ends. On the other hand, if it is determined at step S102 that the update timing is the update timing of the aggregated data, the present control routine proceeds to step S103.

At step S103, the data generation unit 25 updates the aggregated data for each unit area based on the newly collected vehicle data. For example, when the newly collected vehicle data indicates that the dangerous phenomenon counted as a feature value has occurred in a specific unit area, the data creation unit 25 adds a value of the feature value with respect to the aggregated data of the unit area. In the present embodiment, the value of the feature value based on the vehicle data acquired during a predetermined period (e.g., the last three years) is stored in the aggregated data. That is, the vehicle data acquired before the predetermined period is deleted from the aggregated data.

At step S104, the risk determination unit 26 determines the traffic risk for each of the plurality of unit areas included in the target area based on the aggregated data. For example, the risk determination unit 26 determines the traffic risk for each of the plurality of unit areas by inputting the aggregated data of all the unit areas included in the target area to the discriminator. In the present embodiment, according to the output of the discriminator, the traffic risk is classified into three stages of “high”, “medium”, and “low”.

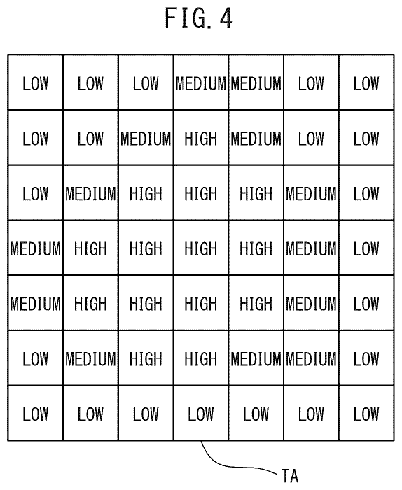

FIG. 4 is a view showing an example of a high-risk area in a target area TA. In FIG. 4, the target area TA includes 49 unit areas, and 14 neighboring unit areas in the target area TA are determined as high-risk areas.

At step S105, the risk reevaluation unit 27 calculates the number N of unit areas determined as a high-risk area by the risk determination unit 26, and assigns the area numbers (1 to N) to each of N unit areas. For example, the area numbers are assigned to the unit areas in ascending order of the mesh code values. In the example of FIG. 4, the number N of unit areas is 14, and numbers 1 to 14 are assigned to the unit areas.

At steps S106 to S108, the traffic risk of the unit area determined as a high-risk area is reevaluated. At step S106, the risk reevaluation unit 27 adds 1 to the area number i. The initial value of the area number i is zero.

At step S107, a subroutine of the risk reevaluation process shown in FIG. 3B is executed. In this subroutine, the traffic risk for the unit area of area number i is reevaluated.

At step S201, the risk reevaluation unit 27 determines whether or not the number of occurrences of the dangerous phenomena in the unit area is zero. This determination is performed, for example, based on the aggregated data generated by the data generation unit 25. If it is determined that the number of times of occurrence of the dangerous phenomena in the unit area is zero, the present control routine proceeds to step S202.

At step S202, the risk reevaluation unit 27 lowers the traffic risk of the unit area. For example, the risk reevaluation unit 27 changes the traffic risk of the unit area from “high” to “medium”. The risk reevaluation unit 27 may change the traffic risk of the unit area from “medium” to “low”. After step S202, the sub routine of FIG. 3B ends, and the control routine proceeds to step S108 of FIG. 3A.

On the other hand, at step S201, if it is determined that the number of times of occurrence of the dangerous phenomena in the unit area is greater than zero, the present control routine proceeds to step S203. In this case, since it is not desirable to reduce the traffic risk of the entire unit area, the unit area is further subdivided and the traffic risk is reevaluated as follows.

At step S203, the risk reevaluation unit 27 subdivides the unit area into small areas narrower than the unit area. In the present embodiment, the risk reevaluation unit 27 subdivides the unit area into small areas so that the number of intersections included in the small areas is one. That is, the mesh size of the small area is determined such that the number of intersections included in the small area is one. For example, when the length of one side of the small area is set to half the length of one side of the unit area, one unit area is subdivided into four small areas.

Hereinafter, the traffic risk of the small area in the unit area is reevaluated. At step S204, the risk reevaluation unit 27 determines whether or not the number of times the intersection in the small area is detected as the blind spot intersection in the vehicle 3 is equal to or greater than a predetermined value. For example, when the blind spot intersection is detected in the vehicle 3 based on the output of the peripheral information detection device, the position information of the blind spot intersection and the like are transmitted from the vehicle 3 to the server 2, and the information is stored in the storage device 22 or the memory 23 of the server 2. The risk reevaluation unit 27 makes the determination in step S204 based on this information.

At step S204, when it is determined that the number of times the intersection in the small area is detected as the blind spot intersection in the vehicle 3 is equal to or greater than the predetermined value, the present control routine proceeds to step S205. In this case, since it is highly likely that a dangerous intersection is actually present in the small area, the risk reevaluation unit 27 maintains the traffic risk of the small area at “high” at step S205.

On the other hand, at step S204, if it is determined that the number of times the intersection in the small area is detected as the blind spot intersection in the vehicle 3 is less than the predetermined value, the present control routine proceeds to step S206. At step S206, the risk reevaluation unit 27 determines whether or not the number of occurrences of the dangerous phenomena in the small area is equal to or greater than a predetermined value. This determination is performed, for example, on the basis of the aggregated data generated by the data generation unit 25 (the number of times of occurrence of the dangerous phenomenon in the small area is calculated from the aggregated data based on the acquired position information of the vehicle data).

At step S206, if it is determined that the number of occurrences of the dangerous phenomena in the small area is equal to or greater than the predetermined number, the present control routine proceeds to step S205. In this case, since there is a high possibility that a potentially dangerous intersection exists in the small area, the risk reevaluation unit 27 maintains the traffic risk of the small area at “high” at step S205.

On the other hand, at step S206, if it is determined that the number of occurrences of the dangerous phenomena in the small area is less than the predetermined value, the present control routine proceeds to step S207. At step S207, the risk reevaluation unit 27 lowers the traffic risk of the small area. For example, the risk reevaluation unit 27 changes the traffic risk of the small area from “high” to “medium”. The risk reevaluation unit 27 may change the traffic risk of the small area from “medium” to “low”.

Each process from step S204 to S207 is performed for each of the plurality of small areas in the unit area, and the traffic risks for each of the plurality of small areas are reevaluated. Note that step S204 may be omitted, and step S206 may be executed after step S203. After step S205 or S207, the subroutine of FIG. 3B ends and the control routine proceeds to step S108 of FIG. 3A.

At step S108, the risk reevaluation unit 27 determines whether or not the area number i is N. That is, the risk reevaluation unit 27 determines whether or not the reevaluation of the traffic risk has been completed for all the unit areas determined as the high-risk area. If it is determined that the area number i is less than N, the control routine returns to step S106, and step S106 and S107 are executed again.

On the other hand, at step S108, if it is determined that the area number i is N, the present control routine proceeds to step S109. At step S109, the risk reevaluation unit 27 resets the area number i to zero.

At step S110, the risk reevaluation unit 27 transmits the hazard map of the target area to each of the plurality of vehicles 3. The hazard map indicates the traffic risks per area in the target area and is referred to by ECU of the vehicles 3. For example, the vehicle 3 does not activate the blind spot intersection assist even when the blind spot intersection is detected when traveling in an area where the traffic risk is “medium” or “low”. In addition, the vehicle 3 may increase the operating strength of the blind spot intersection assist at the blind spot intersection when traveling in an area where the traffic risk is “high”. In this case, for example, the vehicle 3 increases the deceleration of the vehicle 3 at the blind spot intersection. Note that the server 2 may transmit the hazard map to the vehicle 3 only when the update of the hazard map is requested from the vehicle 3. After step S110, the control routine ends.

While preferred embodiments of the present invention have been described above, the present invention is not limited to these embodiments, and various modifications and changes can be made within the scope of the claims. For example, the traffic risk may be classified between two stages of “high” and “low” or may be calculated as a continuous numerical value. In addition, a traffic risk for each time zone may be estimated, and a hazard map for each time zone may be generated. The vehicle data acquired in the vehicle 3 may be transmitted from the vehicle 3 to the server 2 via the roadside device.

1. A traffic risk estimation device comprising:
a data generation unit that generates aggregated data regarding a predetermined dangerous phenomenon from vehicle data acquired in an entire target area including a plurality of unit areas; and
a risk determination unit that determines a traffic risk for each of the plurality of unit areas based on the aggregated data.

2. The traffic risk estimation device according to claim 1, further comprising a risk reevaluation unit that subdivides an area determined to have a high traffic risk into individual area, and reevaluates a traffic risk of the individual area based on the number of occurrences of the dangerous phenomenon in the individual area.

3. The traffic risk estimation device according to claim 2, wherein the individual area is the unit area, and when the number of occurrences of the dangerous phenomenon in the unit area is zero, a traffic risk of the unit area is lowered.

4. The traffic risk estimation device according to claim 2, wherein the individual area is a small area narrower than the unit area, and when the number of occurrences of the dangerous phenomenon in the small area is less than a predetermined value, a traffic risk of the small area is lowered.

5. The traffic risk estimation device according to claim 4, wherein the small area includes only one intersection.
